(19) United States
(12) Patent Application Publication
(10) Pub. No.: US 2017/0146707 A1
(43) Pub. Date: May 25, 2017

(54) SPECTRAL DEVICE AND IMAGE-PICKUP DEVICE

(71) Applicant: Sharp Kabushiki Kaisha, Osaka (JP)

(72) Inventors: Suguru KAWABATA, Sakai City (JP); Takashi NAKANO, Sakai City (JP); Kazuhiro NATSUAKI, Sakai City (JP); Masaaki UCHIHASHI, Sakai City (JP); Masayo UCHIDA, Sakai City (JP)

(21) Appl. No.: 15/341,063

(22) Filed: Nov. 2, 2016

(30) Foreign Application Priority Data
Nov. 20, 2015 (JP) 2015-228116

(51) Int. Cl. G02B 5/20; H04N 5/33; G02B 27/28

(52) U.S. Cl. CPC G02B 5/204; G02B 27/286; G02B 5/201; H04N 5/332

(57) ABSTRACT

A spectral device includes a polarizing filter and an optical filter. The polarizing filter transmits part of light incident on the polarizing filter, the part of light having a particular polarization component. Light that is incident on and passes through the polarizing filter is converted into linearly polarized light. Light that has passed through the polarizing filter is incident on the optical filter. The optical filter transmits light within a particular frequency range. The optical filter includes a metal layer and a dielectric layer. The dielectric layer is disposed on the metal layer. Multiple slits are formed in the metal layer. The multiple slits are arranged at equal intervals in a predetermined direction. The multiple slits extend in a direction perpendicular to a direction in which the light that has passed through the polarizing filter is polarized.

### BACKGROUND

1. Field

The present disclosure relates to spectral devices, more specifically, a spectral device including a slit optical filter that includes a metal layer in which multiple slits are formed at a predetermined pitch, the optical filter transmitting light, most of which falls within a predetermined wavelength range.

2. Description of the Related Art

In recent years, optical filters (slit optical filters) that include a metal layer in which multiple slits are formed at a predetermined pitch to transmit light, most of which falls within a predetermined wavelength range, have been developed. An example of slit optical filters has been disclosed in Japanese Unexamined Patent Application Publication (Translation of PCT Application) No. 2013-525863.

Examples of factors that function as noises during use of optical filters include reflected waves, intervening light from adjacent pixels, light unintendedly leaking out from a gap, and unintended resonant waves. Noises affect spectral characteristics of an object and render true spectral characteristics unknown, which is a problem for an image-pickup device (for example, multispectral camera) including a spectral device having a narrow selective wavelength range. Moreover, in such slit optical filters, full width at half maximum (FWHM) is unintentionally increased by unintended resonant waves or reflected waves.

### SUMMARY

It is desirable to improve the light transmittance of a spectral device including a slit optical filter that includes a metal layer in which multiple slits are formed at a predetermined pitch, the optical filter transmitting light, most of which falls within a predetermined wavelength range.

According to an aspect of the disclosure, a spectral device includes a polarizing filter and an optical filter. The polarizing filter transmits part of light incident on the polarizing filter, the part of light having a particular polarization component. Light that is incident on and passes through the polarizing filter is converted into linearly polarized light. Light that has passed through the polarizing filter is incident on the optical filter. The optical filter transmits light within a particular frequency range. The optical filter includes a metal layer and a dielectric layer. The dielectric layer is disposed on the metal layer. Multiple slits are formed in the metal layer. The multiple slits are arranged at equal intervals in a predetermined direction. The multiple slits extend in a direction perpendicular to a direction in which light that has passed through the polarizing filter is polarized.

A spectral device according to an aspect of the disclosure can have higher light transmittance.

### BRIEF DESCRIPTION OF THE DRAWINGS

FIG. 1 is a diagram of a schematic configuration of an image-pickup device according to a first embodiment of the disclosure;

FIG. 2 is a plan view of a schematic configuration of an optical filter included in the image-pickup device illustrated in FIG. 1;

FIG. 3 is a diagram of a schematic configuration of a filter portion;

FIG. 4A illustrates a method for manufacturing an optical filter, at the stage after the process of sequentially forming a metal layer, a dielectric layer, and a metal layer in this order;

FIG. 4B illustrates a method for manufacturing an optical filter, at the stage after the process of forming slits in the metal layer, the dielectric layer, and the metal layer;

FIG. 4C illustrates a method for manufacturing an optical filter, at the stage after the process of filling the slits with the dielectric layer;

FIG. 5 is a schematic diagram of a relationship between the slits in the optical filter, slits in a polarizing filter, and pixels of a light-receiving portion;

FIG. 6 is a graph of a transmission spectrum of an optical filter;

FIG. 7 is a diagram of a schematic configuration of an image-pickup device according to a first modification example of the first embodiment of the disclosure;

FIG. 8 is a plan view of a schematic configuration of an optical filter employed in an image-pickup device according to a second modification example of the first embodiment;

FIG. 9 is a plan view of a modification example of a filter portion of the optical filter, included in a region corresponding to one pixel;

FIG. 10 is a plan view of another modification example of a filter portion of the optical filter, included in a region corresponding to one pixel;

FIG. 11 is a plan view of another modification example of a filter portion of the optical filter, included in a region corresponding to one pixel;

FIG. 12 is a diagram of a schematic configuration of an optical filter employed in a second embodiment of the disclosure;

FIG. 13 is a graph of simulation results of a transmission spectrum of an optical filter having a metal-insulator-metal (MIM) structure;

FIG. 14 is a graph of simulation results of a transmission spectrum of an optical filter having an insulator-metal (IM) structure;

FIG. 15 is a diagram of a schematic configuration of an image-pickup device according to a third embodiment of the disclosure;

FIG. 16 is a plan view of a schematic configuration of an optical filter employed in a fifth embodiment of the disclosure;

FIG. 17 is a block diagram of a schematic configuration of a controlling unit included in an image-pickup device according to the fifth embodiment of the disclosure; and

FIG. 18 is a graph of spectral characteristics obtained after the controlling unit performs processing.

### DESCRIPTION OF THE EMBODIMENTS

A spectral device according to one embodiment of the disclosure includes a polarizing filter and an optical filter. The polarizing filter transmits part of light incident on the polarizing filter, the part of light having a particular polarization component. Light that is incident on and passes through the polarizing filter is converted into linearly polarized light. Light that has passed through the polarizing filter is incident on the optical filter. The optical filter transmits light within a particular frequency range. The optical filter includes a metal layer and a dielectric layer. The dielectric layer is disposed on the metal layer. Multiple slits are formed in the metal layer. The multiple slits are arranged at equal intervals in a predetermined direction. The multiple slits extend in a direction perpendicular to a direction in which light that has passed through the polarizing filter is polarized.

An image-pickup device according to one embodiment of the disclosure includes a spectral device and a light-receiving portion that detects light that has passed through the spectral device. The spectral device includes a polarizing filter and an optical filter. The polarizing filter transmits part of light incident on the polarizing filter, the part of light having a particular polarization component. Light that is incident on and passes through the polarizing filter is converted into linearly polarized light. Light that has passed through the polarizing filter is incident on the optical filter. The optical filter transmits light within a particular frequency range. The optical filter includes a metal layer and a dielectric layer. The dielectric layer is disposed on the metal layer. Multiple slits are formed in the metal layer. The multiple slits are arranged at equal intervals in a predetermined direction. The multiple slits extend in a direction perpendicular to a direction in which light that has passed through the polarizing filter is polarized.

Referring now to the drawings, specific embodiments of the disclosure are described below. Throughout the drawings, the same or equivalent portions are denoted with the same reference symbols and are not described repeatedly.

### First Embodiment

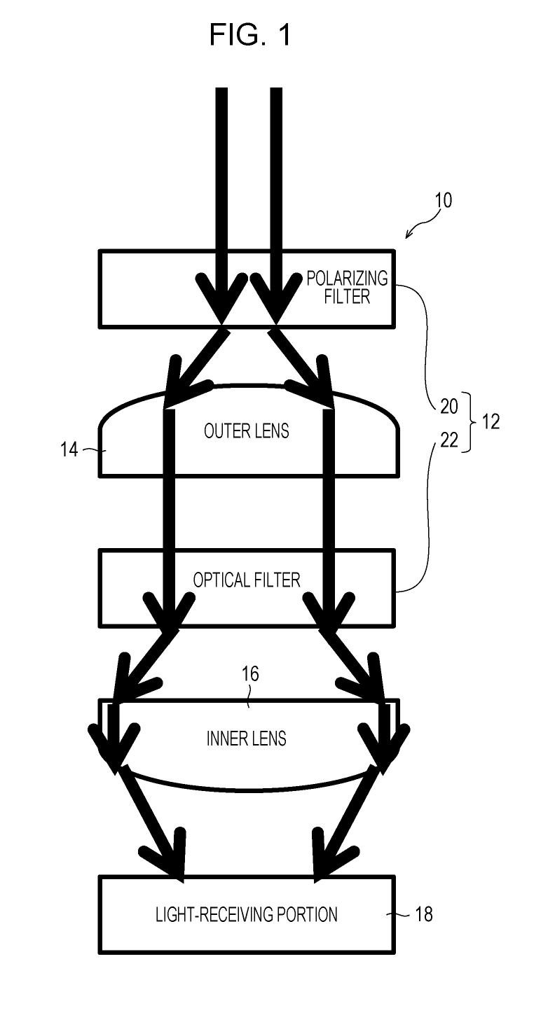

FIG. 1 is a diagram of a schematic configuration of an image-pickup device 10 according to a first embodiment of the disclosure. Arrows in FIG. 1 denote the directions in which light travels. Although not illustrated, an object is disposed on the outer side (side from which light is incident) of a polarizing filter 20. The image-pickup device 10 captures images of the object to obtain spectral characteristics of the object.

The image-pickup device 10 includes a spectral device 12, an outer lens 14, an inner lens 16, and a light-receiving portion 18. The spectral device 12 includes a polarizing filter 20 and an optical filter 22.

The polarizing filter 20 transmits part of light incident on the polarizing filter, the part of light having a particular polarization component (that is, light that oscillates in a particular direction). The polarizing filter 20 converts the incident light into linearly polarized light. In other words, light that is incident on and passes through the polarizing filter 20 is converted into linearly polarized light. The polarizing filter 20 is not limited to be in a particular form as long as it converts incident light into linearly polarized light. For example, a slit polarizing plate is employed as the polarizing filter 20.

The optical filter 22 is located at such a position that light that has passed through the polarizing filter 20 is incident on the optical filter 22. The optical filter 22 transmits light, most of which falls within a particular wavelength range.

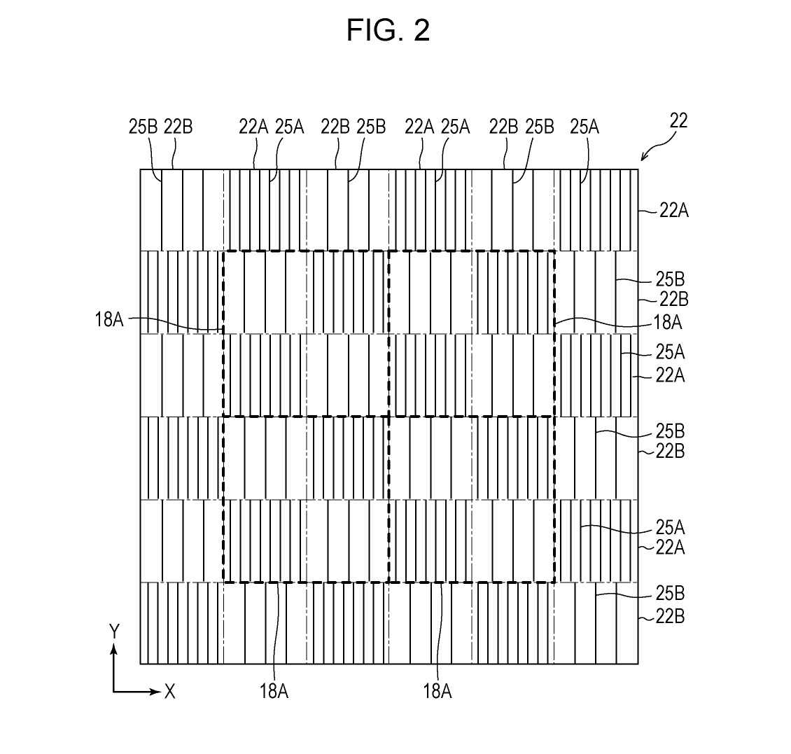

FIG. 2 is a plan view of a schematic configuration of the optical filter 22. The optical filter 22 includes multiple filter portions 22A and multiple filter portions 22B. In FIG. 2, a boundary between each filter portion 22A and the corresponding filter portion 22B is drawn with a dot-dash line. In FIG. 2, areas drawn with broken lines correspond to light-receiving portions, described below.

The filter portions 22A and the filter portions 22B each have a rectangular shape (square shape in this embodiment) in a plan view. In the optical filter 22, the filter portions 22A and the filter portions 22B are alternately arranged in the row and column directions (X and Y directions in FIG. 2). Each filter portion 22A has multiple slits 25A. Each filter portion 22B has multiple slits 25B. The slits 25A in each filter portion 22A extend in the same direction as the slits 25B in each filter portion 22B. The number of slits 25A in each filter portion 22A is larger than the number of slits 25B in each filter portion 22B. The intervals at which the multiple slits 25A are formed in each filter portion 22A are shorter than the intervals at which the multiple slits 25B are formed in each filter portion 22B.

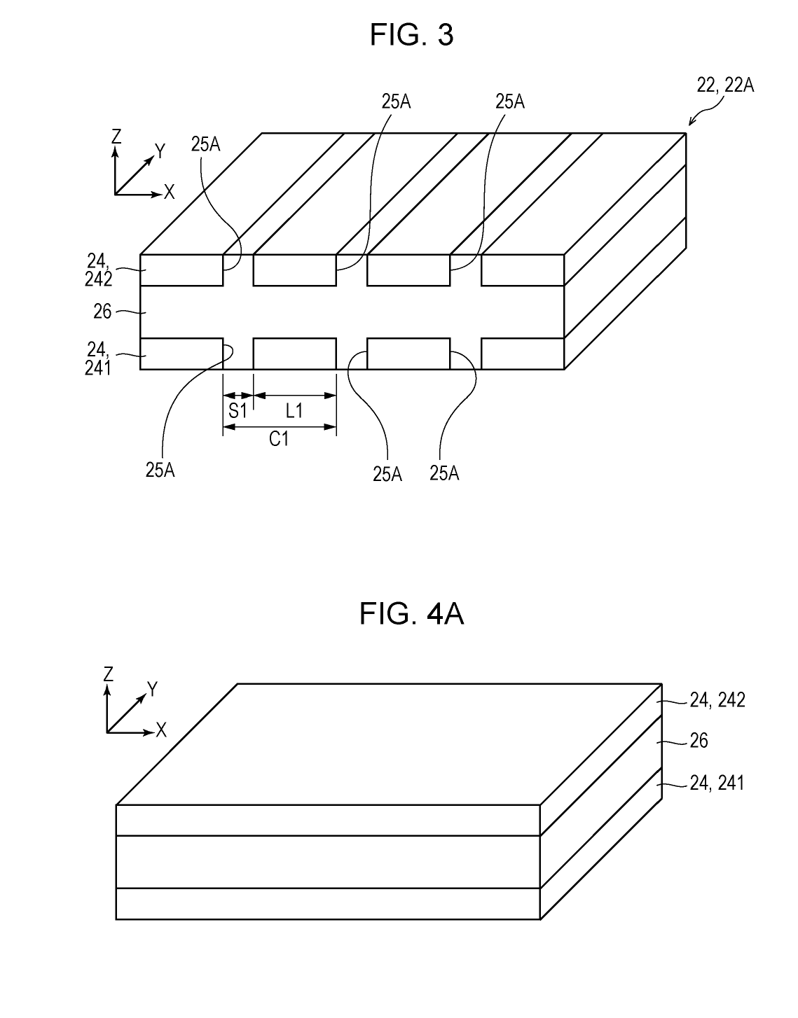

FIG. 3 is a diagram of a schematic configuration of one filter portion 22A of the optical filter 22. Referring to FIG. 3, the filter portion 22A is described. The configuration of each filter portion 22B is basically the same as that of each filter portion 22A except that the number of slits 25B is different from the number of slits 25A. Thus, detailed description on the filter portion 22B is omitted.

Each filter portion 22A includes two metal layers 24 and one dielectric layer 26. In FIG. 3, the width direction of each layer 24 or 26 is denoted with an X direction, the length direction of each layer 24 or 26 is denoted with a Y direction, and the thickness direction (normal direction) of each layer 24 or 26 is denoted with a Z direction.

One of the two metal layers 24 (referred to as a metal layer 241, below) is disposed on a support substrate, not illustrated. The support substrate includes a ground layer and a base substrate. An example of the ground layer is a silicon oxide film. The base substrate transmits light. An example of the base substrate is a glass substrate. When the image-pickup device 10 is used as an image-pickup device, a complementary metal oxide semiconductor (CMOS) device or a charge-coupled device (CCD) is used as an image-pickup element. In this case, an interlayer film formed in the process of forming a contact hole or in the process of forming a wire may be used as a ground layer. In this case, a planarizing process such as chemical-mechanical polishing (CMP) may be performed as needed.

The other one of the two metal layers 24 (hereinafter referred to as a metal layer 242) is disposed apart from the metal layer 241. The metal layer 242 is disposed apart from the metal layer 241 in a direction in which light travels.

The metal layers 24 mostly contain Al. Examples of the material of the metal layers 24 may include Ag, Au, Pt, Ti, TiN, Cu, and AlCu. The refractive index of the metal layers 24 may be within 0.35 to 4.0 in the range of visible light. In this embodiment, the refractive index of the metal layers 24 when light having a wavelength of 550 nm propagates through the metal layer 24 is 0.74.

For the sake of processing convenience, the thickness of the metal layers 24 may be within 20 to 100 nm. In this embodiment, the thickness of the metal layers 24 is 40 nm. The two metal layers 24 may have the same thickness or different thicknesses. In this embodiment, the two metal layers 24 have the same thickness.

The multiple slits 25A are formed in each of the metal layers 24. The multiple slits 25A are formed at equal intervals in a particular direction (X direction or the width direction of the metal layers 24 in the example illustrated in FIG. 3). The multiple slits 25A are formed at the same position of both metal layers 24. A pitch C1 at which multiple slits 25A are formed may be within 140 to 1120 nm. In this embodiment, the pitch C1 is 300 nm.

A width S1 of each slit 25A is appropriately determined in accordance with an intended wavelength (selective wavelength) of light that the filter portion 22A is to transmit. The width S1 may be within 80 to 200 nm. In this embodiment, the width S1 is 100 nm. The width S1 may be within 10 to 50% of the pitch C1. In this embodiment, the width S1 is approximately 33% of the pitch C1. In the example illustrated in FIG. 3, the width S1 is uniform throughout the full length in the longitudinal direction (Y direction in FIG. 3) of each slit 25A. In a strict sense, the width S1 does not have to be uniform throughout the full length in the longitudinal direction of each slit 25A. In the example illustrated in FIG. 3, all the slits 25A have the same width S1.

The length of each slit 25A (dimension in the Y direction in FIG. 3) may be shorter than or equal to the length of the filter portion 22A. The length of each slit 25A may be larger than or equal to ten times a difference L1 between the pitch C1 and the width S1. This configuration can have adequate light transmittance.

The dielectric layer 26 is disposed on the metal layers 24. Portions of the dielectric layer 26 lie in the slits 25A. Examples of the material of the dielectric layer 26 include SiN, ZnSe, SiO₂, and MgF. The material of the portion of the dielectric layer 26 interposed between two metal layers 24 (the portion interposed between the two metal layers 24 in the direction in which light travels, that is, in the vertical direction in FIG. 3) may be the same as or different from the material of the portions of the dielectric layer 26 filled in the slits 25A.

The thickness of the dielectric layer 26 (specifically, the thickness of the portion of the dielectric layer 26 interposed between the two metal layers 24) is appropriately determined in accordance with an intended wavelength (selective wavelength) of light that the optical filter 22 is to transmit. The thickness of the dielectric layer 26 may be within 40 to 200 nm. In this embodiment, the thickness of the dielectric layer 26 is 100 nm. The thickness of the dielectric layer 26 may be within one to five times the thickness of each metal layer 24. In this embodiment, the thickness of the dielectric layer 26 is 2.5 times the thickness of each metal layer 24.

The refractive index of the dielectric layer 26 (specifically, the refractive index of the portion of the dielectric layer 26 interposed between the two metal layers 24) is appropriately determined in accordance with an intended wavelength (selective wavelength) of light that the filter portion 22A is to transmit. The refractive index of the dielectric layer 26 can be changed, for example, by changing the material of the dielectric layer 26. The refractive index of the dielectric layer 26 may be larger than 1.4 and smaller than or equal to 3.0.

Each filter portion 22A transmits part of light incident on the polarizing filter, the part of light mostly within a particular wavelength range, using a phenomenon similar to a resonance phenomenon at the interface between each metal layer 24 and the dielectric layer 26. By optimizing parameters affecting this phenomenon (such as the thickness of each metal layer 24, the width of the slits 25A in each metal layer 24, the pitch of the slits 25A, the thickness of the dielectric layer 26, or the refractive index of the dielectric layer 26), the light transmittance of the filter portion 22A can be improved.

The thickness of each metal layer 24 or the dielectric layer 26, the width S1 of the slits 25A, or the pitch C1 of the slits 25A has to be changed in accordance with the properties of the material of each layer 24 or 26 (particularly, the refractive index) or the selective wavelength. Particularly, the refractive index has to be calculated in advance for each selective wavelength through simulation since the refractive index has wavelength dependency. The selective wavelength depends on the difference L1 and the thickness of the dielectric layer 26.

The material of each layer 24 or 26 is not limited to the examples described above. Any material that causes plasmon resonance at the interface between each metal layer 24 and the dielectric layer 26 is usable. Specifically, any material having a negative dielectric constant is usable as a material of the metal layer 24. The refractive index of the dielectric layer 26 will suffice if it is higher than the refractive index (1.4) of the ground layer (silicon oxide film) on which the metal layer 241 is disposed.

Now, a method for manufacturing the optical filter 22 is described.

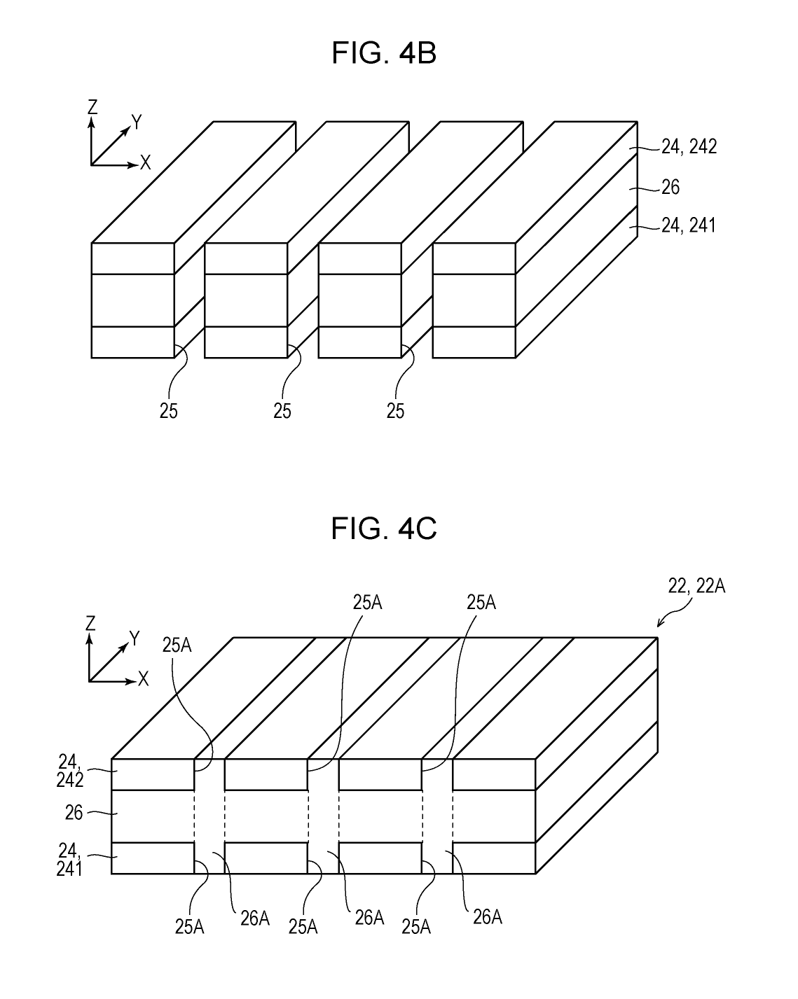

As illustrated in FIG. 4A, first, the metal layer 241, the dielectric layer 26, and the metal layer 242 are sequentially formed on the support substrate in this order. Specifically, the metal layer 241 is formed on the support substrate by sputtering. The dielectric layer 26 is formed on the metal layer 241 by chemical vapor deposition (CVD). The metal layer 242 is formed on the dielectric layer 26 by sputtering.

Subsequently, as illustrated in FIG. 4B, slits 25 are formed in the metal layer 241, the dielectric layer 26, and the metal layer 242 by photolithography. Thereafter, a dielectric layer 26A is formed so that the slits 25 are filled with the dielectric layer 26A. Thus, the optical filter 22 illustrated in FIG. 4C is complete. Here, FIG. 4C illustrates the filter portion 22A, which is part of the optical filter 22. In FIG. 4C, the surface of the metal layer 242 opposite to the surface facing the metal layer 241, that is, opposite to the surface touching the dielectric layer 26 may be covered with a dielectric layer.

Referring back to FIG. 1, the description continues. The outer lens 14 is disposed between the polarizing filter 20 and the optical filter 22. In other words, light that has passed through the polarizing filter 20 is incident on the outer lens 14, light that has passed through the outer lens 14 is incident on the optical filter 22, and the outer lens 14 converts the light that has passed through the polarizing filter 20 into plane-wave light. In other words, light that has passed through the outer lens 14 is plane-wave light. The optical filter 22 is irradiated with the plane-wave light.

The inner lens 16 is disposed between the optical filter 22 and the light-receiving portion 18. Specifically, light that has passed through the optical filter 22 is incident on the inner lens 16. Light that has passed through the inner lens 16 is incident on the light-receiving portion 18. The inner lens 16 concentrates the incident light on the light-receiving portion 18.

The light-receiving portion 18 receives light that has passed through the inner lens 16. The light-receiving portion 18 is an image-pickup element.

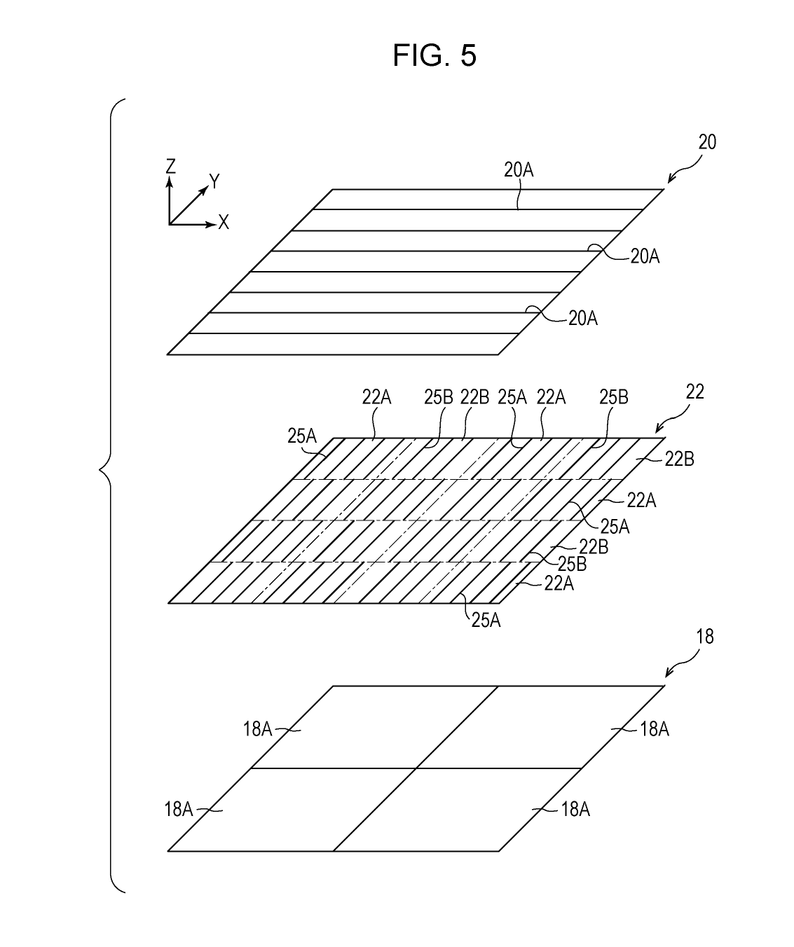

As illustrated in FIG. 5, the light-receiving portion 18 includes multiple pixels 18A. The multiple pixels 18A are arrayed in row and column directions (X and Y directions in FIG. 5). As illustrated in FIGS. 2 and 5, each pixel 18A has a size the same as the size of a set of four filter portions, including two filter portions 22A and two filter portions 22B arrayed in two rows and two columns. Each pixel 18A includes, for example, a photodiode.

As illustrated in FIG. 5, the direction in which the slits 25A and the slits 25B in the optical filter 22 extend is perpendicular to the direction in which slits 20A in the polarizing filter 20 extend. Thus, light that has passed through the optical filter 22 is less likely to contain noise. The reason is described below.

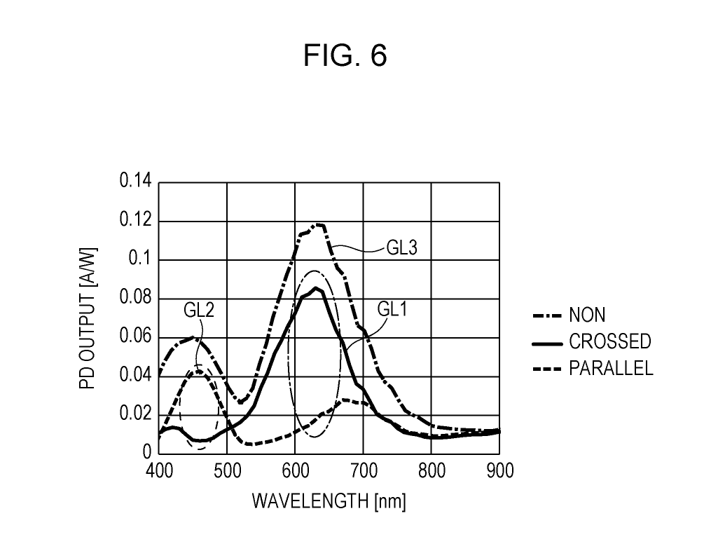

FIG. 6 is a graph of the spectral characteristics of light detected by the light-receiving portion. In FIG. 6, a graph GL1 represents the spectral characteristics of light that the light-receiving portion has detected when the direction in which the slits in the optical filter extend is perpendicular to the direction in which the slits in the polarizing filter extend. In FIG. 6, a graph GL2 represents the spectral characteristics of light that the light-receiving portion has detected when the direction in which the slits in the optical filter extend is parallel to the direction in which the slits in the polarizing filter extend. In FIG. 6, a graph GL3 represents the spectral characteristics of light that the light-receiving portion has detected when a polarizing filter is not disposed.

As illustrated in FIG. 6, when the direction in which the slits in the optical filter extend is perpendicular to the direction in which the slits in the polarizing filter extend (as in the case of graph GL1), the noise peak around 450 nm is lower (see the portion encircled with a broken line in FIG. 6) and the main peak around 640 nm is higher (see the portion encircled with a dot-dash line in FIG. 6) than in the case where the direction in which the slits in the optical filter extend is parallel to the direction in which the slits in the polarizing filter extend (as in the case of graph GL2). When the slits in the optical filter are perpendicular to the slits in the polarizing filter, the spectral device 12 functions as a band-pass filter effective against noise.

The optical filter 22 enables concurrent selection of the wavelength and the direction in which light is polarized. Here, the wavelength has a correlation with the pitch between the slits 25A or 25B. The direction in which light is polarized has a correlation with the direction in which the slits 25A or 25B extend. These parameters can be designed independently of each other.

To manufacture the optical filter 22, a single exposure mask can determine the pitch between the slits 25A or 25B or the direction in which the slits 25A or 25B extend. Thus, a single exposure process will basically suffice for manufacturing the optical filter 22 having various different filter portions (that is, selective wavelengths). Thus, the manufacturing of the optical filter 22 using a single exposure mask can significantly reduce the number of die sets or processes compared to the case of manufacturing an optical filter using an organic film or a multilayer film.

Moreover, a change of an exposure mask layout can appropriately change the selective wavelength or the direction in which light is polarized.

In addition, the optical filter can be formed by using a material usually used in a semiconductor manufacturing process such as aluminum or silicon.

The image-pickup device 10 includes the outer lens 14. Thus, the optical filter 22 has higher spectral characteristics. The reason is described below.

The optical filter 22 has low spectral characteristics (that is, low performance of transmitting light within a particular wavelength range) when light is obliquely incident on the optical filter 22. Thus, the outer lens 14 is disposed to convert light incident on the optical filter 22 into a plane wave, so that the optical filter 22 has higher spectral characteristics.

The image-pickup device 10 includes the inner lens 16. Thus, the light-receiving portion 18 has higher sensitivity to light. The reason is described below.

Light that has passed through the optical filter 22 is converted into a spherical wave. Thus, the inner lens 16 is disposed to concentrate the light that has passed through the optical filter 22 on the light-receiving portion 18, so that the light-receiving portion 18 has higher sensitivity to light.

As described above, the image-pickup device 10 includes the outer lens 14 and the inner lens 16. Thus, the image-pickup device 10 can produce an image having higher contrast.

### First Modification Example of First Embodiment

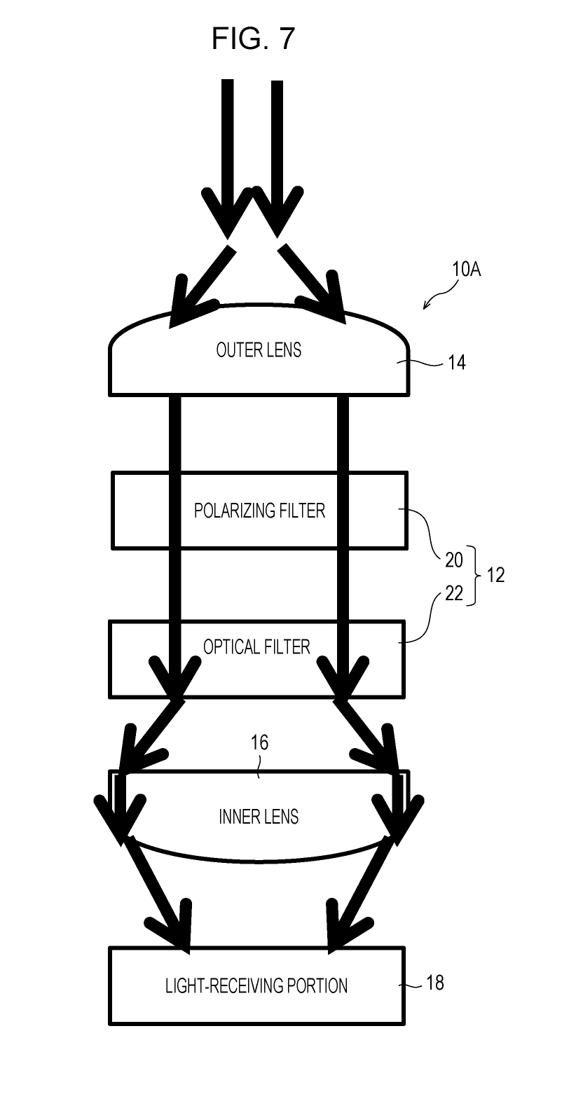

FIG. 7 is a diagram illustrating an image-pickup device 10A according to a first modification example of the first embodiment. The image-pickup device 10A differs from the image-pickup device 10 in terms of the position of the outer lens 14. In the image-pickup device 10A, the outer lens 14 is disposed on the side of the polarizing filter 20 from which light is incident. The configuration in which the outer lens 14 is disposed at this position can also obtain the same effects as in the case of the first embodiment.

### Second Modification Example of First Embodiment

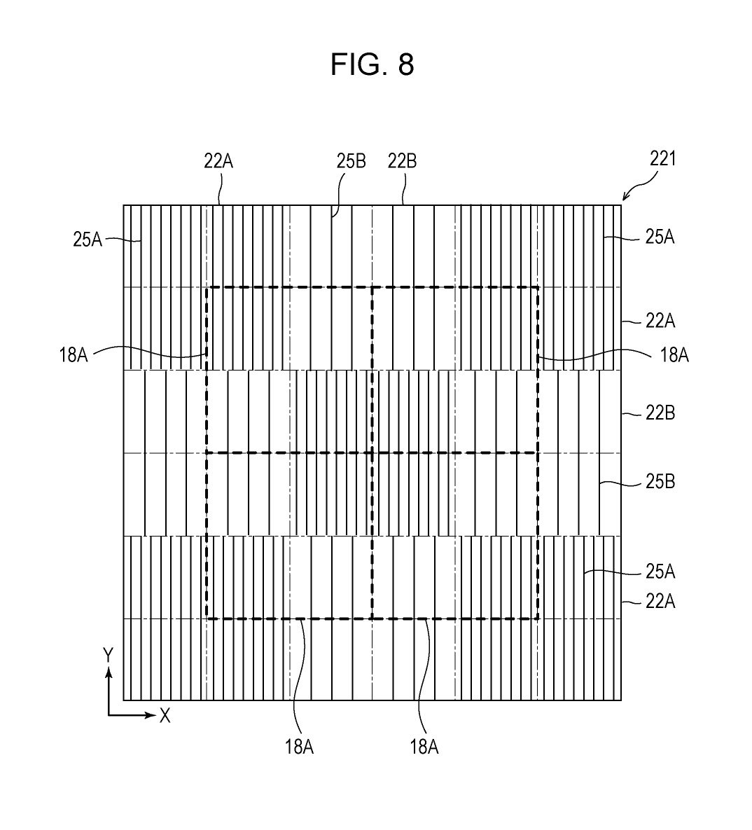

FIG. 8 is a plan view of the schematic configuration of an optical filter 221 employed in an image-pickup device of a second modification example of the first embodiment. In FIG. 8, a boundary between each filter portion 22A and the corresponding filter portion 22B is drawn with a dot-dash line. In FIG. 8, an area drawn with a broken line corresponds to a light-receiving portion, described below.

In contrast to the case of the optical filter 22 illustrated in FIG. 2, each of the filter portions 22A and the filter portions 22B in the optical filter 221 illustrated in FIG. 8 has the same size as each pixel 18A. In this case, the length of the slits 25A or 25B can be increased to approximately two times the length of the slits 25A or 25B in the example illustrated in FIG. 2. The number of slits 25A or 25B can be increased to approximately two times the number of slits 25A or 25B in the example illustrated in FIG. 2. In the example illustrated in FIG. 8, the filter portions 22A and the filter portions 22B are disposed, not at the positions coinciding with the positions of the pixels 18A, but at the positions shifted from the positions of the pixels 18A by half the dimensions in the row and column directions (X and Y directions in FIG. 8). In the example illustrated in FIG. 8, the pixels 18A having a smaller size can retain their light transmittance, so that the optical filter 221 can have the same spectral characteristics as in the case of FIG. 2. In addition, the interference noise that occurs between filter portions having different patterns can be reduced.

### Third Modification Example of First Embodiment

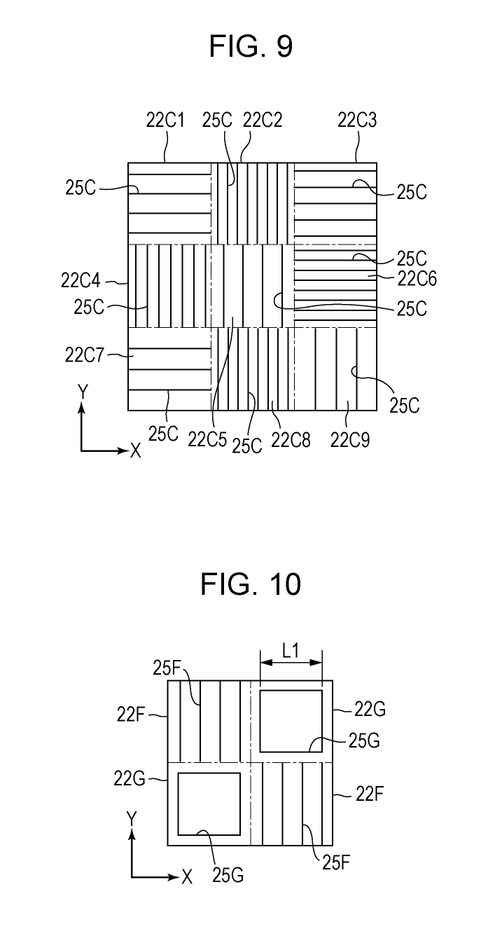

For example, as illustrated in FIG. 9, nine filter portions 22C1 to 22C9 may be arrayed in three rows and three columns in an area of an optical filter corresponding to one pixel 18A. Slits 25C in one of the filter portions 22C1 to 22C9 may extend in a direction the same as or different from the direction in which slits 25C in another one of the filter portions 22C1 to 22C9 extend. Slits 25C in one of the filter portions 22C1 to 22C9 that extend in the same direction as the slits 25C in another one of the filter portions 22C1 to 22C9 are formed at intervals different from the intervals at which the slits in the other one of the filter portions 22C1 to 22C9 are formed. When the slits in one of the filter portions 22C1 to 22C9 extend in a direction different from a direction in which slits in another filter portion extend, the polarizing filter 20 is disposed so as to be rotatable relative to the optical filter 22. Here, one of the filter portions 22C1 to 22C9 is selected from the multiple filter portions 22C1 to 22C9 and the polarizing filter 20 is rotated relative to the optical filter 22 so that the direction in which the slits 25C of the selected one of the filter portions 22C1 to 22C9 extend is perpendicular to the direction in which the silts 20A of the polarizing filter 20 extend.

### Fourth Modification Example of First Embodiment

When, for example, the polarizing filter 20 is disposed so as to be rotatable relative to the optical filter 22, the polarizing filter 20 may have multiple filter portions in each of which the direction in which slits extend or the pitch between the slits differs from the direction or the pitch in the other filter portions. In this case, the optical filter 22 may omit multiple filter portions in each of which the direction in which slits extend or the pitch between the slits differs from the direction or the pitch in the other filter portions. Thus, an exposure mask layout used for forming silts in the optical filter 22 is simplified, so that a design margin is widened.

### Fifth Modification Example of First Embodiment

In the first embodiment, two filter portions 22A and two filter portions 22B, that is, two pairs of filters portions having the same selective wavelength, are disposed in an area of the optical filter 22 corresponding to one pixel 18A. However, multiple filter portions disposed in the area of the optical filter 22 corresponding to one pixel 18A may individually have different selective wavelengths.

### Sixth Modification Example of First Embodiment

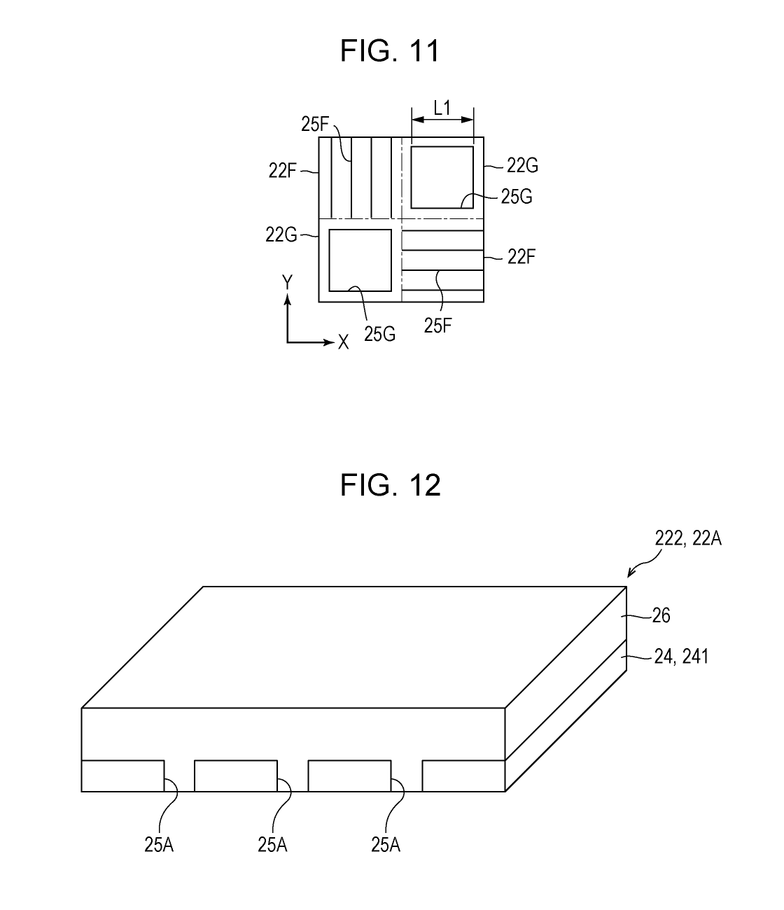

In the first embodiment, multiple filter portions disposed in the area corresponding to one pixel 18A each have slits. However, as illustrated in FIGS. 10 and 11, multiple filter portions disposed in the area corresponding to one pixel 18A may include a filter portion 22F in which slits 25F are formed and a filter portion 22G in which an opening 25G is formed.

In the case where multiple filter portions 22F are included, the slits 25F in all the filter portions 22F may extend in the same direction or different directions. In the case where multiple filter portions 22F are included, the slits 25F in all the filter portions 22F may be formed at the same pitch or different pitches.

The opening 25G in the filter portion 22G may have any shape. For example, the opening 25G may be square, as illustrated in FIG. 10 and FIG. 11, or may be polygonal or circular. Light that passes through the filter portion 22G has polarization characteristics the same as the polarization characteristics of light that passes through the polarizing filter 20.

When the filter portion 22G has light transmittance excessively higher than the light transmittance of the filter portion 22F, the light transmittance of the filter portion 22G can be changed to intended light transmittance by adjusting the area of the opening 25G. In the example illustrated in FIG. 10 and FIG. 11, for example, the area of the opening 25G may be adjusted by changing the length L1 on each side of the opening 25G.

The form illustrated in FIG. 10 or FIG. 11 is particularly effective for the case where calculations of a polarization band-pass filter and a polarization edge pass filter are performed within the same frame. For example, the form is effective for the case where an object having a high gloss is subjected to spectral evaluations. This is because this form enables a real-time measurement of wavelength characteristics while the gloss of the objects is being reduced by polarization.

The method for adjusting the light transmittance of the filter portion 22G and the light transmittance of the filter portion 22F is not limited to the above-described adjustment of the area of the opening 25G. For example, besides the adjustment of the area of the opening 25G, the length of the slits 25F may also be adjusted as needed. In some cases, only the adjustment of the length of the slits 25F may suffice.

In the case where multiple filter portions 22G are included, the openings 25G in the filter portions 22G may have the same size or different sizes.

### Seventh Modification Example of First Embodiment

For example, in the first embodiment, the image-pickup device 10 may omit the outer lens 14 and the inner lens 16.

### Second Embodiment

Referring to FIG. 12, a second embodiment of the disclosure is described. FIG. 12 is a diagram of a schematic configuration of the filter portion 22A of an optical filter 222 employed in this embodiment. In contrast to the optical filter 22, the optical filter 222 does not include a metal layer 242.

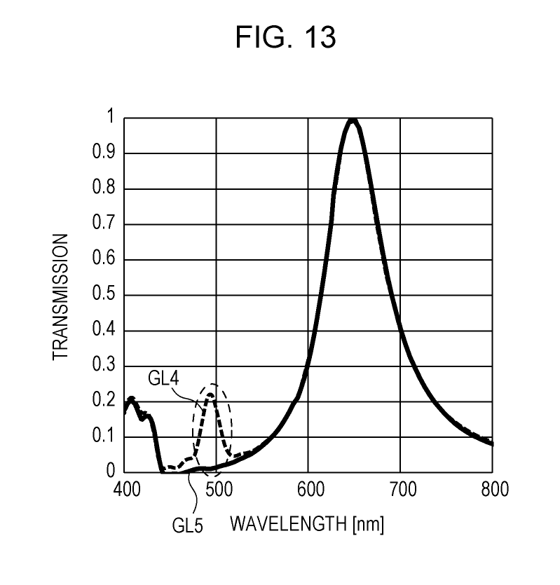

FIG. 13 is a graph of simulation results of the transmission spectrum of the optical filter 22. Specifically, a graph GL4 represents the transmission spectrum obtained when a polarized light ray perpendicular to the slits 25A and 25B of the optical filter 22 and a polarized light ray parallel to the slits 25A and 25B are incident on the slits 25A and 25B. A graph GL5 represents the transmission spectrum obtained when only a polarized light ray perpendicular to the slits 25A and 25B of the optical filter 22 is incident on the slits 25A and 25B.

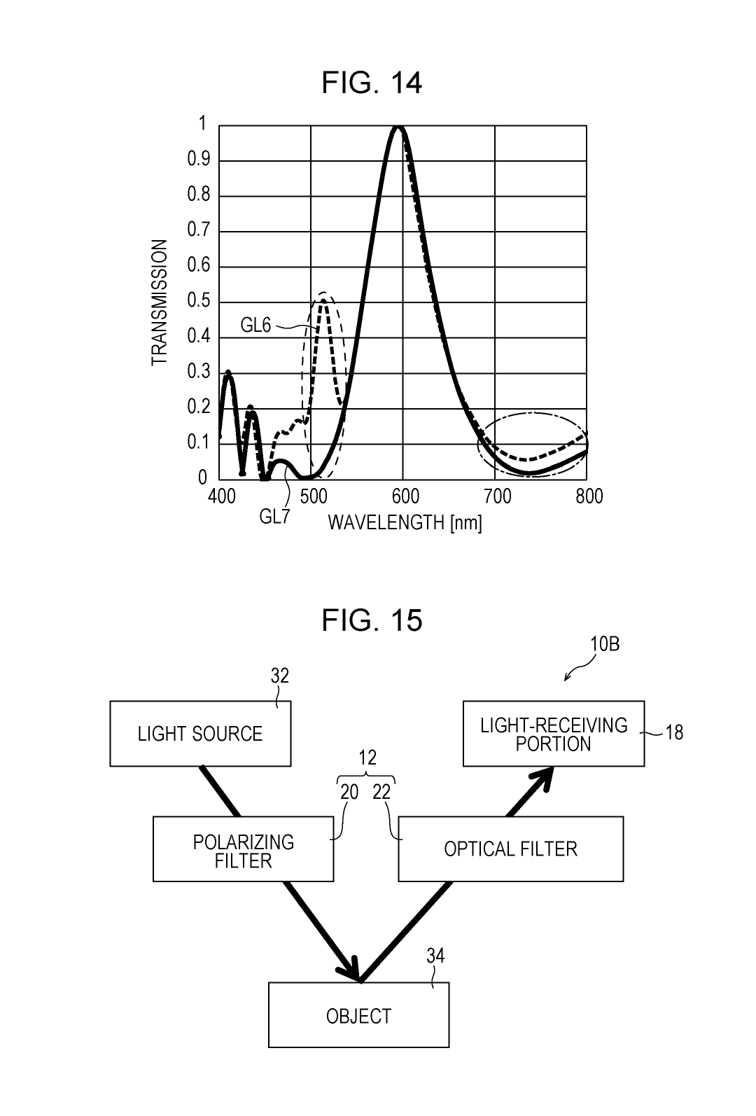

FIG. 14 is a graph of simulation results of the transmission spectrum of the optical filter 222. Specifically, a graph GL6 represents the transmission spectrum obtained when a polarized light ray perpendicular to the slits 25A of the optical filter 222 and a polarized light ray parallel to the slits 25A are incident on the slits 25A. A graph GL7 represents the transmission spectrum obtained when only a polarized light ray perpendicular to the slits 25A of the optical filter 222 is incident on the slits 25A.

Simulations in both cases were performed by finite difference time domain (FDTD). The reason why the peak wavelength differs between FIG. 13 and FIG. 14 is because of the difference between the structures of the optical filter 22 and the optical filter 222.

As illustrated in FIG. 13, the optical filter 22 is capable of excluding the unintended resonance peak around 500 nm (see the portion encircled with a broken line). As illustrated in FIG. 14, the optical filter 222 is capable of excluding the resonance peak around 520 nm (see the portion encircled with a broken line). In addition, the optical filter 222 is capable of reducing a leakage of light in a long wavelength range of 700 nm or higher (see the portion encircled with a dot-dash line).

In contrast to the optical filter 22, the optical filter 222 does not include the metal layer 242. Thus, the shape of the metal layer 241 is more easily fixed when slits are formed therein. Thus, the optical filter 222 is manufactured at higher yield than in the case of the optical filter 22.

### Third Embodiment

Referring to FIG. 15, an image-pickup device 10B according to a third embodiment of the disclosure is described. FIG. 15 is a diagram of a schematic configuration of the image-pickup device 10B.

In contrast to the image-pickup device 10, the image-pickup device 10B includes a light source 32. The light from the light source 32 passes through the polarizing filter 20. The light that has passed through the polarizing filter 20 is shone on an object 34 and reflected off the object 34. The light reflected off the object 34 is incident on the optical filter 22. The light incident on the optical filter 22 is then incident on the light-receiving portion 18. Thus, the spectrum of the object 34 is obtained.

When the surface of the object 34 is to be observed, the direction in which slits in the optical filter 22 extend may be rendered perpendicular to the direction in which slits in the polarizing filter 20 extend.

To obtain information inside the object 34, the direction in which the slits in the polarizing filter 20 extend and the direction in which the slits in the optical filter 22 extend are adjusted in consideration of an optical path difference. The information inside the object 34 is a diffuse reflection component. A polarized mirror reflection component (for example, S-wave or P-wave) functions as a noise for a diffuse reflection component. Thus, this noise is reduced by adjusting the direction in which the slits in the polarizing filter 20 extend and the direction in which the slits in the optical filter 22 extend. Specifically, the direction in which the slits in the polarizing filter 20 extend is rendered perpendicular to the direction in which the slits in the optical filter 22 extend.

The polarizing filter 20 may be installed on the light source 32 or on the object 34.

### Fourth Embodiment

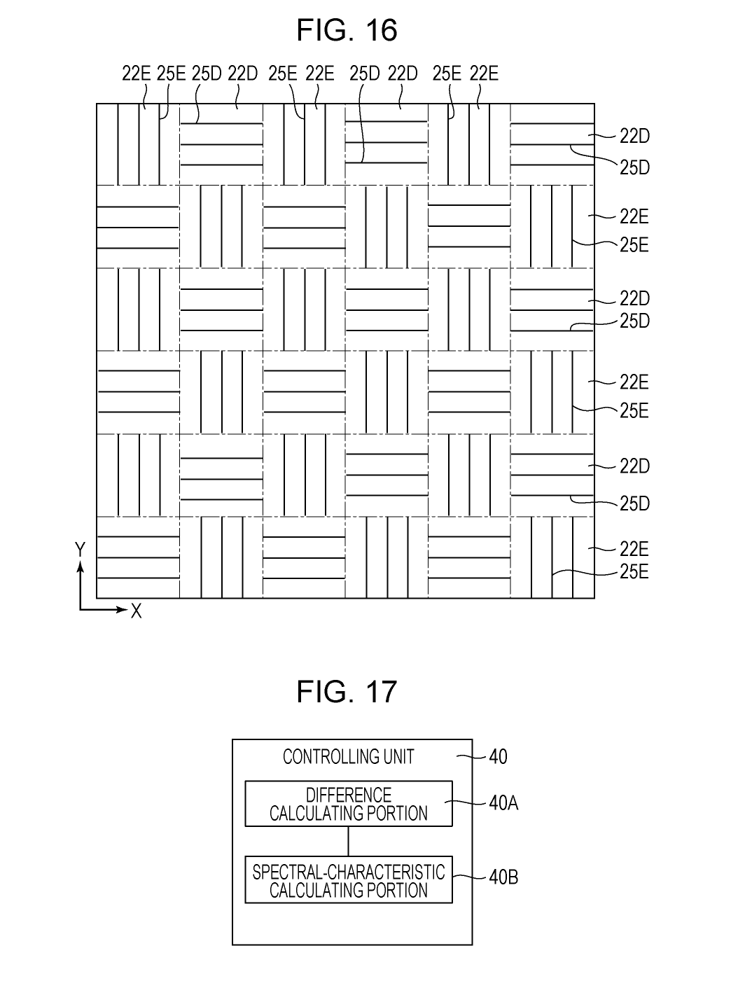

FIG. 16 is a plan view of a schematic configuration of an optical filter 223 employed in a fourth embodiment of the disclosure. In the optical filter 223, slits 25D in one filter portion 22D extend in a direction perpendicular to the direction in which slits 25E of an adjacent filter portion 22E extend. In this embodiment, the direction in which the slits 25D in the filter portion 22D extend is parallel to the direction in which the slits 20A in the polarizing filter 20 extend, whereas the direction in which the slits 25E in the filter portion 22E extend is perpendicular to the direction in which the slits 20A in the polarizing filter 20 extend. In this embodiment, the light-receiving portion 18 includes a pixel in a region corresponding to each of the multiple filter portions 22D and 22E in the optical filter 223.

FIG. 17 is a block diagram of a controlling unit 40 included in an image-pickup device according to the embodiment. The controlling unit 40 includes a difference calculating portion 40A and a spectral-characteristic calculating portion 40B. The difference calculating portion 40A calculates a difference between a detection value of light that has passed through one of the filter portions 22D and that has been detected at the pixel disposed in the region corresponding to the filter portion 22D and a detection value of light that has passed through one of the filter portions 22E and that has been detected at the pixel disposed in the region corresponding to the filter portion 22E. The spectral-characteristic calculating portion 40B calculates the spectral characteristics of light that the light-receiving portion 18 has detected on the basis of the calculation result of the difference calculating portion 40A.

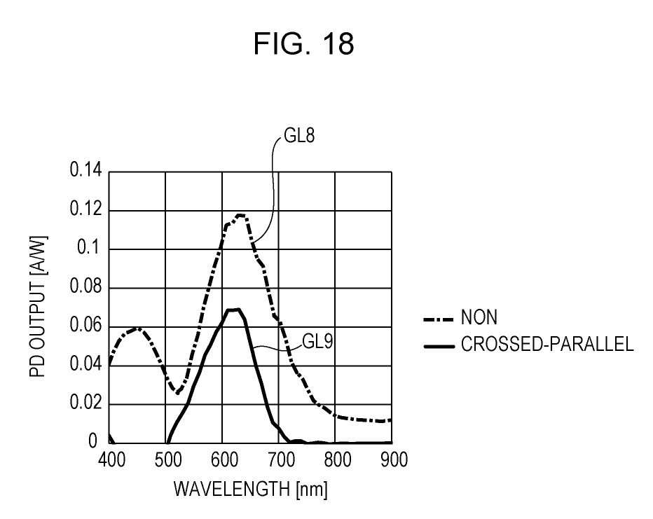

FIG. 18 is a graph of the spectral characteristics of light that the light-receiving portion 18 has detected. Specifically, a graph GL8 represents the spectral characteristics of light detected by the light-receiving portion 18 in a configuration that does not include the polarizing filter 20. A graph GL9 represents calculation results of the spectral-characteristic calculating portion 40B. As illustrated in FIG. 18, this embodiment can exclude a noise around 450 nm. If noise exclusion fails as a result of a mere calculation of the difference in the above-described manner, a light source may be modified or an auxiliary filter may be used. In FIG. 18, a negative value is calculated within a range of 500 nm or lower. When a negative value is not handleable, part of light having a wavelength of 500 nm or lower may be cut by, for example, a blue cut filter.

Thus far, embodiments of the disclosure have been described in detail. These embodiments, however, are mere examples and the disclosure is not at all limited by the above-described embodiments.

The present disclosure contains subject matter related to that disclosed in Japanese Priority Patent Application JP 2015-228116 filed in the Japan Patent Office on Nov. 20, 2015, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A spectral device, comprising:
a polarizing filter that transmits part of light incident on the polarizing filter, the part of light having a particular polarization component; and
an optical filter on which light that has passed through the polarizing filter is incident and that transmits light within a particular frequency range,
wherein light that is incident on and passes through the polarizing filter is converted into linearly polarized light,
wherein the optical filter includes
a metal layer in which a plurality of slits are formed at equal intervals in a predetermined direction, and
a dielectric layer on the metal layer, and
wherein the plurality of slits extend in a direction perpendicular to a direction in which the light that has passed through the polarizing filter is polarized.

2. The spectral device according to claim 1,
wherein the optical filter includes
a first filter, and
a second filter adjacent to the first filter, and
wherein intervals at which the plurality of slits are formed in the first filter are different from intervals at which the plurality of slits are formed in the second filter.

3. The spectral device according to claim 1,
wherein the optical filter includes
a first filter, and
a second filter adjacent to the first filter, and
wherein a direction in which the plurality of slits extend in the first filter is different from a direction in which the plurality of slits extend in the second filter.

4. The spectral device according to claim 3,
wherein the polarizing filter is disposed so as to be rotatable relative to the optical filter,
wherein a position of the polarizing filter relative to the optical filter includes
a first position in which a direction in which the plurality of slits extend in the first filter is perpendicular to the direction in which the light that has passed through the polarizing filter is polarized, and
a second position in which a direction in which the plurality of slits extend in the second filter is perpendicular to the direction in which the light that has passed through the polarizing filter is polarized.

5. An image-pickup device, comprising:
a spectral device; and
a light-receiving portion that detects light that has passed through the spectral device,
wherein the spectral device includes
a polarizing filter that transmits part of light incident on the polarizing filter, the part of light having a particular polarization component, and
an optical filter on which light that has passed through the polarizing filter is incident and that transmits light within a particular frequency range,
wherein light that is incident on and passes through the polarizing filter is converted into linearly polarized light,
wherein the optical filter includes
a metal layer in which a plurality of slits are formed at equal intervals in a predetermined direction, and
a dielectric layer on the metal layer, and
wherein the plurality of slits extend in a direction perpendicular to a direction in which the light that has passed through the polarizing filter is polarized.

6. The image-pickup device according to claim 5, further comprising:
a first lens on a side of the optical filter from which light is incident,
wherein light that is incident on and passes through the first lens is converted into a plane wave.

7. The image-pickup device according to claim 6, further comprising:
a second lens between the optical filter and the light-receiving portion,
wherein light that is incident on and passes through the second lens is concentrated on the light-receiving portion.

8. The image-pickup device according to claim 5, further comprising:
a light source that shines light on an object,
wherein the light source is disposed on a side of the polarizing filter from which light is incident,
wherein the object is disposed at such a position that the light that has passed through the polarizing filter is shone on the object, and
wherein the optical filter is disposed at such a position that part of light shone on the object is incident on the optical filter, the part of light being reflected by the object.

9. The image-pickup device according to claim 5,
wherein the light-receiving portion includes
a first light-receiving portion, and
a second light-receiving portion adjacent to the first light-receiving portion,
wherein the optical filter includes
a first filter, and
a second filter adjacent to the first filter,
wherein a direction in which the plurality of slits extend in the first filter is different from a direction in which the plurality of slits extend in the second filter, and
wherein the image-pickup device further comprises:
a difference calculating portion that calculates a difference between a detection value obtained by the first light-receiving portion and a detection value obtained by the second light-receiving portion; and
a spectral-characteristic calculating portion that calculates spectral characteristics of light detected by the light-receiving portion using the difference calculated by the difference calculating portion.
